(19) United States
(12) Patent Application Publication
(10) Pub. No.: US 2006/0180631 A1
(43) Pub. Date: Aug. 17, 2006

(54) Electric motor driven energy storage device for impacting

(76) Inventors: Chris Pedicini, Nashville, TN (US); John Witzigreuter, Canton, GA (US)

Correspondence Address: Wilson Daniel Swayze, Jr., 3804 Clearwater Ct., Plano, TX, 75025, US

(21) Appl. No.: 11/352,527

(22) Filed: Feb. 13, 2006

Related U.S. Application Data
(60) Provisional application No. 60/653,571, filed on Feb. 16, 2005.

(51) Int. Cl. B25C 1/04

(52) U.S. Cl. 227/130; 227/2; 227/8

(57) ABSTRACT

A portable electric fastening tool operating from a power supply. The motor moves a piston which compresses air against a sealed chamber. The piston is coupled to a fastener impacting anvil and is released after sufficient energy is stored in the air chamber. The air energetically expands pushing the piston and fastener driving anvil into the substrate. The actuation is governed by a control circuit and initiated from a trigger switch. The stored energy delivered from the motor is coupled to the output anvil and drives the nail. At least one position of the output anvil is sensed and once the nail is driven, the power can be disconnected from the motor. This method uses a rack and a pinion to drive the piston thus reducing wear and increasing efficiency of the device. Elastic bumpers are used at the end of the stroke to limit stresses during the impact. The electrical control circuit and sensors allow precise control and improve safety. An intermediate clutch is used to increase reliability and performance. The power supply is preferably a rechargeable low impedance battery pack.

### PRIORITY

The present invention claims priority under 35 USC section 119 based on the patent application 60/653,571 filed on Feb. 16, 2005.

### FIELD OF THE INVENTION

This invention relates to fastening mechanisms, specifically to such nail or staple fastening mechanisms that require operation as a hand tool.

### BACKGROUND OF INVENTION

An electromechanical fastener-driving tool weighs generally less than 15 pounds and is completely suitable for an entirely portable operation.

Contractors and homeowners commonly use power-assisted means of driving fasteners into wood. These power assisted means of driving fasteners can be either in the form of finishing nail systems used in baseboards or crown molding in house and household projects, or in the form of common nail systems that are used to make walls or hang sheathing onto same. These systems can be portable (not connected or tethered to an air compressor or wall outlet) or non-portable.

The most common fastening system uses a source of compressed air to actuate a cylinder to push a nail into the receiving members. For applications in which portability is not required, this is a very functional system and allows rapid delivery of fasteners for quick assembly. A disadvantage is that it does however require that the user purchase an air compressor and associated air-lines in order to use this system.

To solve this problem, several types of portable nail guns operate off of fuel cells. Typically, these guns have a cylinder in which a fuel is introduced along with oxygen from the air. The subsequent mixture is ignited with the resulting expansion of gases pushing the cylinder and thus driving the nail into the work pieces. Typical within this design is the need for a fairly complicated assembly. Both electricity and fuel are required as the spark source derives its energy typically from batteries. In addition, it requires the chambering of an explosive mixture of fuel and the use of consumable fuel cartridges. Systems such as these are already in existence and are sold commercially to contractors under the Paslode name.

There are other nail guns that are available commercially, which operate using electrical energy. They are commonly found as electric staplers and electric brad tackers. The normal mode of operation for these devices is through the use of a solenoid that is driven off of a power cord that is plugged into a wall outlet. One of the drawbacks of these types of mechanisms is that the number of ampere-turns in the solenoid governs the force provided by a solenoid. In order to obtain the high forces required for driving brads and staples into the work piece, a large number of turns are required in addition to high current pulses. These requirements are counterproductive because the resistance of the coil increases in direct proportion to the length of the wire in the solenoid windings. The increased resistance necessitates an increase in the operational voltage in order to keep the current thru the windings at a high level and thus the ampere-turns at a sufficiently large level to obtain the high forces needed to drive the nail. This type of design suffers from a second drawback in that the force in a solenoid varies in relation to the distance of the solenoid core from the center of the windings. This limits most solenoid driven mechanisms to short stroke small load applications such as paper staplers or small brad tackers.

The prior art teaches three additional ways of driving a nail or staple. The first technique is based on a multiple impact design. In this design, a motor or other power source is connected to the impact anvil thru either a lost motion coupling or other device. This allows the power source to make multiple impacts on the nail to drive it into the work piece. There are several disadvantages in this design that include increased operator fatigue since the actuation technique is a series of blows rather than a continuous drive motion. A further disadvantage is that this technique requires the use of an energy absorbing mechanism once the nail is seated. This is needed to prevent the heavy anvil from causing excessive damage to the substrate. Additionally, the multiple impact designs normally require a very heavy mechanism to insure that the driver does not move during the driving operation.

A second design that is taught in U.S. Pat. Nos. 3,589,588, 5,503,319 and 3,172,121 includes the use of potential energy storage mechanisms in the form of a mechanical spring. In these designs, the spring is cocked (or activated) through an electric motor. Once the spring is sufficiently compressed, the energy is released from the spring into the anvil (or nail driving piece) thus pushing the nail into the substrate. Several drawbacks exist to this design. These include the need for a complex system of compressing and controlling the spring, and in order to store sufficient energy, the spring must be very heavy and bulky. Additionally, the spring suffers from fatigue giving the tool a very short life. Finally, metal springs must move a significant amount of mass in order to decompress, and the result is that the low speed nail drivers result in a high reactionary force on the user. A third means for driving a fastener that is taught includes the use of flywheels as energy storage means. The flywheels are used to launch a hammering anvil that impacts the nail. This design is described in detail in U.S. Pat. Nos. 4,042,036, 5,511,715 and 5,320,270. The major drawback to this design is the problem of coupling the flywheel to the driving anvil. This prior art teaches the use of a friction clutching mechanism that is both complicated, heavy and subject to wear. This design also suffers from difficulty in controlling the energy left over after the nail is driven. Operator fatigue is also a concern as significant precession forces are present with flywheels that rotate in a continuous manner. An additional method of using a flywheel to store energy to drive a fastener is detailed in British Patent 2,000,716. This patent teaches the use of a continuously rotating flywheel coupled to a toggle link mechanism to drive a fastener. This design is limited by the large precession forces incurred because of the continuously rotating flywheel and the complicated and unreliable nature of the toggle link mechanism.

U.S. Pat. No. 4,215,808 teaches of compressing air within a cylinder and then releasing the compressed air by use of a gear drive. This patent overcomes some of the problems associated with the mechanical spring driven fasteners described above, but is subject to other limitations. Limitations of this design include safety hazards in the event that the anvil jambs on the downward stroke. The device has no provision for either jamb recovery or tool restart in the event the anvil stalled on the downstroke. Clearing the jamb would subject the user to the full force of the air driven anvil, causing potential injury. Additionally, since there is no mechanical bias or sensors, once the unit gets out of time thru a jamb, recovery would have to be by manual techniques. This design is further subject to a complicated drive system for coupling and uncoupling the air spring from the drive train. Finally, by not including control features such as motor braking and sensing position of the rack, the design is unreliable for robust use.

U.S. Pat. No. 5,720,423 again teaches of an air spring which is compressed and then released to drive the nail. The drive or compression mechanism used in this device is limited in stroke and thus is limited in the amount of energy which can be stored into the air stream. In order to get sufficient energy in the air stream to achieve good performance, this patent teaches use of a gas supply which preloads the cylinder at a pressure higher then atmospheric. Furthermore, the compression mechanism is bulky and complicated. In addition, the timing of the motor is complicated by the small amount of time between the release of the piston and anvil assembly from the drive mechanism and its subsequent re-engagement. Additionally, U.S. Pat. No. 5,720,423 teaches that the anvil begins in the retracted position which further complicates and increases the size of the drive mechanism.

All of the currently available devices suffer from one or more disadvantages which include:
1. Complex design. With the fuel driven mechanisms, portability is achieved but the design is complicated. Mechanisms from the prior art that utilize rotating flywheels have complicated coupling or clutching mechanisms based on frictional means. Devices that use springs to store potential energy suffer from reliability and complicated spring compression mechanisms.
2. Noisy. The ignition of an explosive mixture to drive a nail causes a very loud sound and presents combustion fumes in the vicinity of the device. Multiple impact devices are fatiguing and are noisy.
3. Complex operation. Combustion driven portable nail guns are more complicated to operate. They require fuel cartridges that need to be replaced, and the combustion chamber must be cleaned.
4. Use of consumables. Combustion driven portable nail gun designs use a fuel cell that dispenses a flammable mixture into the piston combustion area. The degree of control over the nail driving operation is very crude as you are trying to control the explosion of a combustible mixture.
5. Non-portability. Traditional nail guns are tethered to a fixed compressor and thus must maintain a separate supply line.
6. High Reaction force and short life. Mechanical spring driven mechanisms have high tool reaction forces because of their long nail drive times. Additionally, the springs are not rated for these types of duty cycles leading to premature failure.
7. Complicated and bulky designs. The “air spring” driven designs described use a complicated mechanism which is unwieldy and leads to a bulky tool. Additionally, they are not robust in error recovery and can be hazardous during jamb conditions.

### BRIEF SUMMARY OF THE INVENTION

In accordance with the present invention, a fastening tool is described which derives its power from a low impedance electrical source, preferably rechargeable batteries, and uses a motor to transfer energy thru a linear motion converter into a piston which compresses air and stores the energy in the form of an air spring. The linear motion converter releases at a predetermined point thus allowing the compressed air to expand behind the piston and drive an anvil which pushes the fastener into the substrate. Upon receipt of an actuation signal from an electrical switch, a circuit connects a motor to the electrical power source. The motor is coupled to the linear motion converter preferably through a speed reduction mechanism. The linear motion converter changes the rotational motion of the motor into linear translating movement of the piston inside a cylinder. After the motor is connected to the power source, the gears and motor begin to spin which begins to transfer energy into the air spring formed by the piston and a closed end of a cylinder. When sufficient energy has been transferred to the air spring which is generally governed by the decoupling point of the linear motion converter to the drive train, the air spring freely moves the piston and fastener driving anvil through an output stroke. The preferred linear motion converter is a rack and pinion. In one design, some of the teeth of the pinion are removed which allows the rack, piston and anvil assembly to disengage from the drive when the rack is presented with the missing pinion teeth. At this disengagement point, the piston, rack and anvil assembly (fastener driving output assembly) is freely driven by the highly compressed air and rapidly drives the fastener into the substrate. Near the end of the fastener driving output assembly, a bumper is encountered to absorb any excess energy in the fastener driving output assembly which prevents system damage. The position of the fastener driving output assembly is sensed by at least one sensor to allow for the circuit to determine when it has completed the stroke and is in position for another stroke. Once the fastener driving output assembly has decoupled from the motor drive assembly, a sensor can be used to detect this event. This is used to disengage a clutch or coordinate power removal and braking of the motor depending on which embodiment of the invention is employed. The motor and gear train can coast to a stop or a brake can be used to stop the drive train and motor very quickly. The preferred mode for braking is dynamic braking from the motor. In the most robust embodiment, a clutch is inserted within the drive train and preferably between the linear motion converter and the gear reduction mechanism. This clutch increases tool performance by allowing the decoupling of the drive mechanism from the linear motion converter to be independent of the geometry thus increasing tool flexibility. For example in the linear motion converter including a rack and rack pinion, this eliminates the need to cut away rack pinion teeth and thus allows full tooth engagement during the drive cycle. This permits smaller face width gears which reduces the mass in the piston, rack and anvil assembly thus increasing the fastener drive speed and reducing the tool reaction force during the drive cycle. Additionally, tool efficiency and responsiveness are improved as the trigger can be used to engage the clutch so motor braking is not required.

Upon completion of the drive cycle, the fastener driving mechanism moves back to its starting position via an elastic biasing means such as residual air pressure in the chamber or preferably a mechanical spring. Once it is in position at the starting point, a sensor is preferably used to signify the control circuit that the cycle is considered complete, and the tool is ready to initiate another cycle.

Various biasing elements such as mechanical springs, elastic bungees or air pressure can be used to return the linear motion converter to a predetermined position for reliable operation. Additionally, in the event of a jamb during the fastener driving stroke, a mechanical or electrically operated vent for the air spring can be included to allow for safe depressurization and ease of reset.

Accordingly, in addition to the objects and advantages of the portable electric nail gun as described above, several objects and advantages of the present invention are:
1. To provide a robust method for storage and rapid releasing of energy from a motor to a fastener.
2. To provide an electric motor driven fastener driving means which is simple to construct and inexpensive to produce.
3. To provide a fastener driving mechanism that has low moving inertia during the nail drive.
4. To provide a fastener driving device which uses an air spring to store and release energy to the fastener driving mechanism.
5. To provide an electrically driven high power fastener-driving device that has little wear.
6. To provide an electric motor driven fastener-driving device which has a fast drive stroke thus reducing reaction force.
7. To provide an electric motor driven fastener-driving mechanism which has a clutch coupling to improve rate of fire, efficiency and wear.

Further objects and advantages will become more apparent from a consideration of the ensuing description and drawings.

### DESCRIPTION OF THE SEVERAL VIEWS OF THE DRAWINGS

The invention may be understood by reference to the following description taken in conjunction with the accompanying drawings, in which, like reference numerals identify like elements, and in which:

FIG. 1 is a side assembly view of the electric motor driven fastener-driving tool in the anvil forward or down position.

FIG. 2 is a side assembly view of the electric motor driven fastener-driving tool in the anvil top or retracted position.

FIG. 3 is a side assembly view of the rack and pinion piston drive assembly.

FIG. 4 is a side assembly view showing a retaining mechanism.

FIG. 5 is a sketch of the mechanism using an intermediate clutch

FIG. 6 is a block diagram of a control circuit.

### REFERENCE NUMBERS IN DRAWINGS

1 Motor
2 Power Source
3 Control Circuit
4 Rack
5 Piston
6 Fastener
7 Gear Reduction/Drive Train
8 Anvil
9 Linear Motion Converter
10 Start Switch
11 Drive Train Sensor
12 Piston Position Sensor
13 Air Chamber
14 Cylinder
15 Bolt Link
16 Pinion Cutaway Teeth
17 Bumper
18 Substrate
19 Fastener Feeder
20 Positioning Spring
21 Thermister
22 Unused
23 Release Valve
24 Not Used
25 Drive Train
26 Piston Return Spring
27 Not Used
28 Sear Pin/Lever
29 Grip
30 Support Bearing
31 Rack Pinion
32 Trigger
33 Unused
34 Clutch
62 Microprocessor
64 Power switching elements
100 Apparatus

### DETAILED DESCRIPTION OF THE INVENTION

The operation of the invention in driving a fastener into a substrate has significant improvements over that which is available and that which has been described in the art. First, fasteners are loaded into a magazine structure. The nailing device is then placed against the substrates, which are to be fastened, and the trigger is actuated. The fastener driving device transfers energy from the motor to an air spring storage system which is subsequently released into the fastener driving mechanism pushing the fastener into the substrate. The transfer of energy from the motor to the air spring is thru a linear motion converter being shown as a rack and pinion type mechanism. Once the anvil returns to its starting position, a cycle is complete.

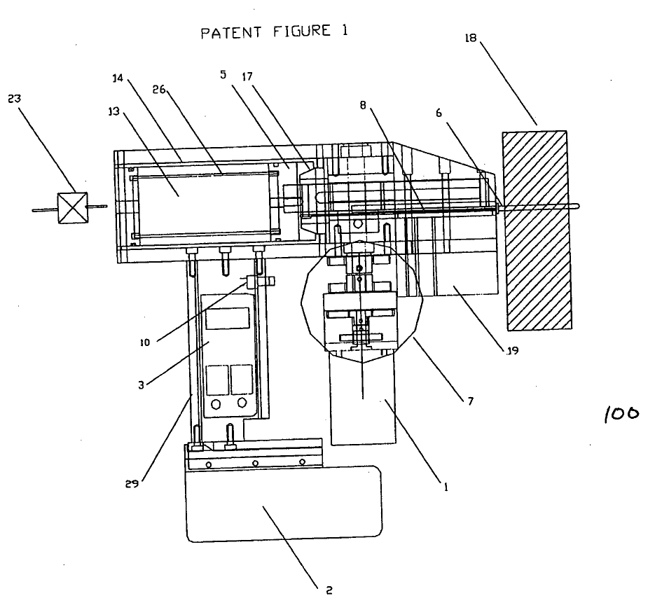

FIG. 1 shows a fastener device (100) including a motor (1) to receive power from a power source (2) which may be a battery or from an electrical cord and to energize the drive train (7), the power source (2) which may be a rechargeable battery to provide power to the motor (1), a control circuit (3) to control the fastener device (100), a drive train (7) which may include a gear reduction system a linear motion converter (9), a fastener driving anvil (8) to drive the fastener (6) into the substrate (18) and a fastener feeder (19) which supplies the fasteners (6) to the fastener driver anvil (8). FIG. 1 additionally shows a start switch (10) to stop and start the fastener device (100) and shows a piston (5) to move within the cylinder (14). At one end of the cylinder (14) is positioned bumper (17) to stop the piston (5). A release valve (23) is used to replenish the air which may be lost between nail drives. Positioned across the air chamber (13) is a piston return spring (26) to return the piston (5) to the resting position. In FIG. 1, the fastener driver anvil (8) is shown resting in its initial forward position biased by piston return spring (26). Upon activating the start switch (10), power is connected to the motor (1) from the power source (2) thru the control circuit (3). Although the control circuit (3) includes switching elements and semiconductors, it is recognized that any apparatus for directing power to the motor in order to complete the fastener drive cycle could be used. Once the motor (1) receives power from the power source (2), the motor (1) activates the drive train (7) which may include turning the gear reduction system to drive the linear motion converter (9). The linear motion converter (9) which may include a rack (4) which is coupled to the piston (5) to travel with piston (5) and detachedly coupled to the rack pinion (31) to drive the rack (4) The rack (4) and/or piston (5) is also coupled to the fastener-driving anvil (8). Rotation of the rack pinion (31) by the drive train (7) and which may be coupled to the gear reduction system causes the rack (4) of the linear motion converter (9) to start moving generally parallel to the fastener and towards the back of the fastener device (100). This in turn moves the piston (5) towards the back of the fastener device (100) thereby compressing the air in the cylinder (14) and energizing the piston return spring (26). The piston return spring (26) functions to bias the piston (5) and linear motion converter (9) assembly to its starting position as shown in FIG. 1. Although, it is possible to precharge the air chamber (13) to eliminate the piston return spring (26), this is not preferable since it complicates recovering from fastener jambs. Furthermore, precharging the air chamber (13) requires a long-term seal for the air chamber thus making the design less robust. The use of a piston return or biasing spring allows less stringent seal requirements on the cylinder. Additionally, a small valve (23) is used to replenish the air which may be lost between nail drives. This valve is preferably designed to allow sufficient air leakage such that the anvil is not loaded by pressure from the air chamber (13) during a fastener drive jamb. Such a valve could be a ball check valve, reed valve or electric valve.

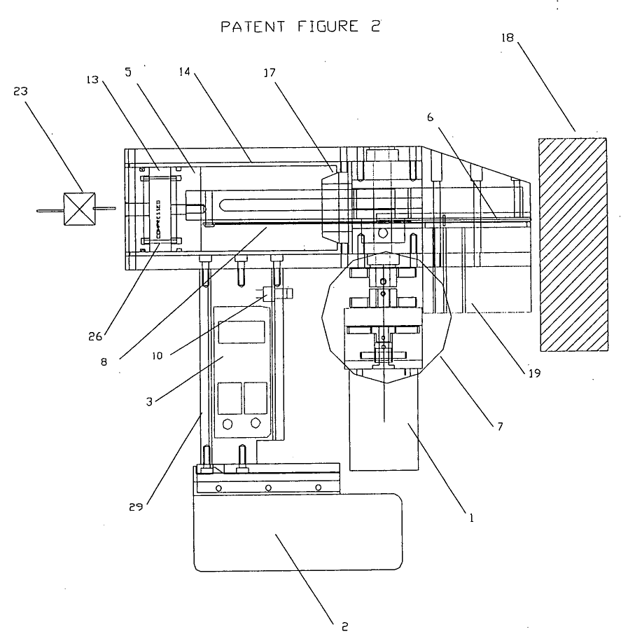

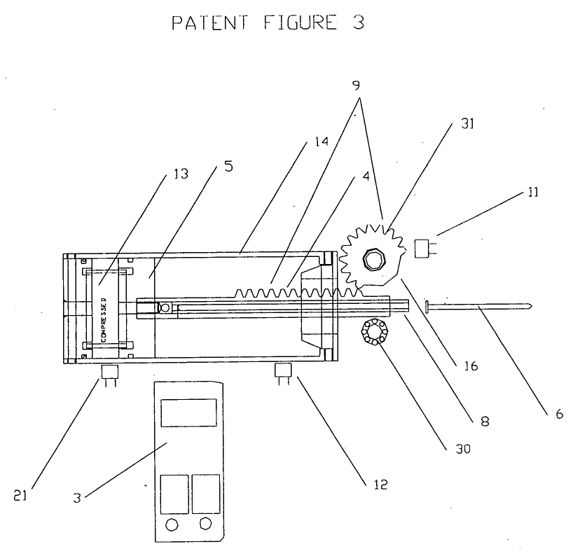

During rotation of the motor (1) which is driving the rack pinion (31) thru the drive train (7) the piston (5) moves further in the cylinder (14) compressing the air in the air chamber (13). This compression of air results in storage of a large amount of energy into the air contained within the air chamber (13). During the period of time in which the piston (5), anvil (8) and rack (4) are moved further into the cylinder (14), the anvil (8) clears the fastener head allowing a fastener (6) to be fed underneath the anvil (8) and into a position suitable for driving the fastener (6). The rack pinion (31) may not have continuous teeth formed around the periphery of the rack pinion (31). Alternatively, the rack pinion (31) as illustrated in FIG. 3 may have a pinion cutaway teeth (16) which is positioned on a portion of the periphery of the rack pinion (31) that does not have teeth. Further rotation of the rack pinion (31) brings the rack pinion cutaway teeth (16) opposite the rack (4). In FIG. 3, it is noted that both the last pinion and rack tooth have a radiused profile. This reduces the gear teeth wear which would occur with during tip loading on standard gear teeth. When the rack pinion cutaway teeth (16) are opposite the rack (4), the rack (4), piston (6) and anvil (8) are free to travel to the front of the fastener device (100) as a result of the compressed air force from the air chamber (13) and a lack of restraint from the pinion cutaway teeth (16). The rack pinion (31) is decoupled from the rack (4), the piston (6) and anvil (8). The rack (4), piston (5) and anvil (8) assembly rapidly accelerate under the force of the compressed air and drive the fastener (6) into the substrate (18) as shown in FIG. 2. Once the drive cycle is complete, the anvil (8), piston (5) and rack (4) are again in the initial position. The piston return spring (26) or other elastic element assists in this positioning by moving the anvil (8), piston (5) and rack (4) towards the forward, downward or initial position. A sensor (12) may be used to determine the position of the anvil (8), piston (5) and rack (4) in the forward position to notify the control circuit (3) that the fastener device (100) is ready for another cycle. A further sensor (11) is preferably used to detect the decoupling of the drive train (7) from the linear motion converter (9). This sensor (11) can be used so that the control circuit (3) removes the power source (2) from the motor (1) or disconnects an intermediate clutch (34) as described in a further embodiment. Although the drive train (7) or gear reduction system may be described as a plurality of spur gears other apparatus such as planetary gears, worm gears, belt or chain drives could be used without departing from the spirit of the invention. This cycle ends when the fastener (6) has been driven into the substrate (18) and the linear motion converter (9) has returned to its forward or initial position. This cycle can take up to approximately 1 second but preferably takes less than 250 milliseconds.

In a specific example, for a 16 gage finish nailer which needs about 25 foot pounds of energy to fully drive the fastener, an approximate 30:1 gear reduction system with a rack pinion pitch diameter of about 1″ is used. The total stroke is about 2.5″ and about ¼% of the rack pinion teeth are cutaway. The air pressure within the chamber may reach about 120 psi on a 2.25″ diameter cylinder resulting in a starting force on the piston of about 480 lbs. This force is sufficient to accelerate a mass of 0.35 lb such mass of the linearly moving rack (4), piston (5) and anvil (8) to a velocity of over 500 inches per second resulting in a fastener drive time of less then 5 milliseconds. Obviously, variations in the starting masses, cylinder diameters, drive train elements and linear motion converter could be made without departing from the spirit of the invention.

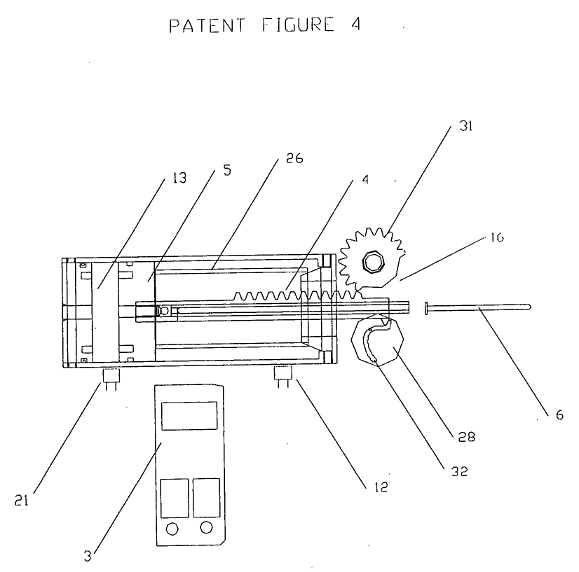

A further embodiment of this design includes a sear pin or lever (28) which maintains the rack (4), piston (5) and anvil (80) in the energized state. This embodiment is depicted in FIG. 4. Upon actuation of the trigger (32) of the sear lever, the mechanism is released and energetically pushes the fastener into the substrate. The mechanism senses the completion of the stroke and then the motor (1) is engaged to rewind the mechanism to the reactivated state. This approach has the advantage that the time between the sear lever actuation (or trigger pull) and the seating of the fastener is very small since the energy is already stored in air chamber (13) thus resulting in a more responsive feel to the tool. The disadvantage includes losing the benefit of the heat of compression of the air thus reducing the overall efficiency. In this embodiment, the initial point for the anvil (8), piston (5) and rack (4) would be in the up position and an energized state of the air chamber (13).

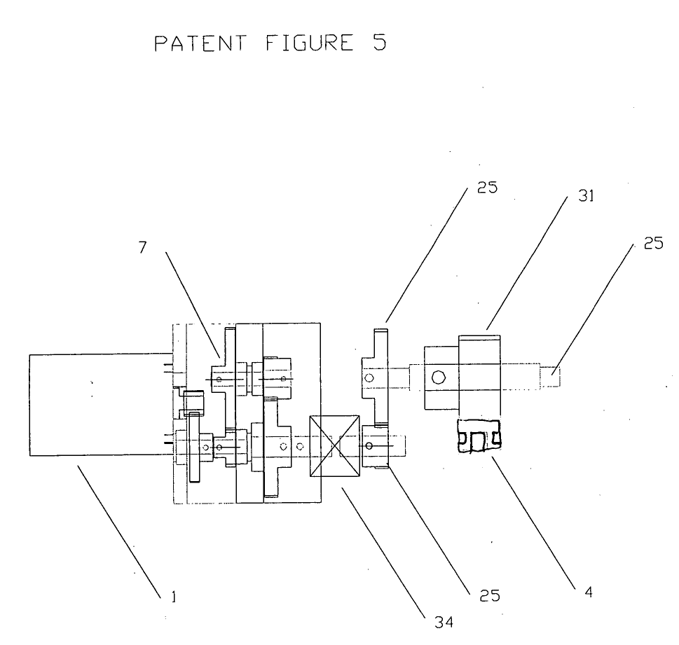

A final embodiment to the design includes the addition of an intermediate clutch (34) between the portion of the drive train (25) and the linear motion converter as shown in FIG. 5. The advantages of this embodiment include allowing the drive train (motor and reduction system) to come up to speed while allowing for a controlled engagement of the linear motion converter. In this embodiment the drive train (7) can be accelerated in response to the nose of the tool being depressed up against the substrate. The engagement of the clutch (34) could then be controlled in response to the pull of the start switch (10). Although the clutch engagement could be electrically or mechanically coordinated, it is preferred to be electrically coordinated to increase tool flexibility. This embodiment allows for more precise control of fastener drive energy since the release of the air spring can be controlled independently of the previously described linear motion converter rack and pinion geometry. Another advantage of this embodiment is when the substrate (18) includes soft materials, the clutch (34) could be controlled by the control circuit (3) to decrease the drive energy to release the anvil (8) at a lower pressure within the air spring. A further advantage of an electrical control of the clutch (34) would be to inhibit the engagement of the air spring until sufficient energy was built up within the drive train (7) to ensure that the air compression and release could be completed. Alternatively or in addition to, if the motor (1) stalls during the air spring compression, the clutch (34) could be released to allow the unit to complete a cycle reducing the chance of a jamb condition. Furthermore, with the clutch (34) being controlled by the control circuit (3), the rack pinion (31) may have continuous teeth eliminating the need for the pinion cutaway teeth (16) and tip loading of a single tooth could be avoided. This greatly reduces wear and improves tool performance by allowing for decreased face width gears to be used. The preferred clutch for this type of application would be an electrically actuated wrap spring clutch. This type of clutch has excellent power density and is suitable for rapid cycling. Other clutches such as ball ramp clutches, friction clutches or electromagnetic clutches could be used as well.

In this embodiment, the trigger (32) causes the clutch (34) to engage the drive train (7) with the rack pinion thus allowing it to complete a fastener drive cycle. Since the disengagement point of the rack (4), anvil (8) and piston (5) from the rack pinion is dependant on the clutch; The amount of compression can be controlled in the air chamber (13) by controlling the position of the clutch disengagement. This disengagement could be in response to determining the position of the piston within the air cylinder or in response to other inputs such as timers or motor current. In this way, the fastener drive energy could be more optimized to the various substrates as required. Upon disengagement, the motor could either continue to run or be disconnected from the power source depending on the type of tool operation required.

Preferred Circuit Operation

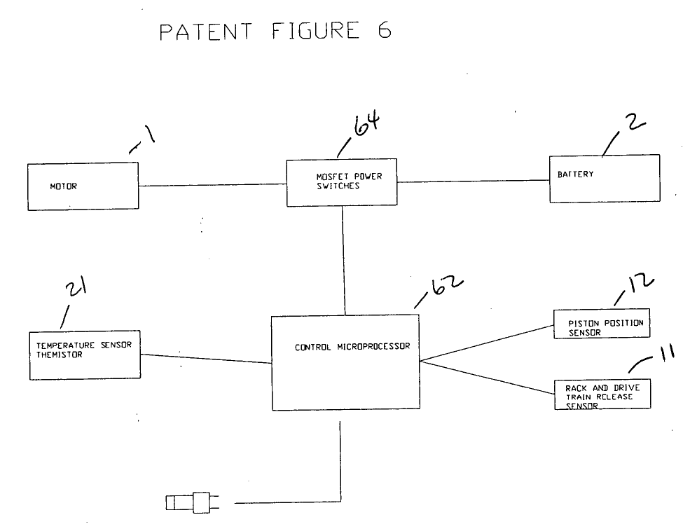

A block representation of a control circuit is shown in FIG. 6. In the preferred embodiment, the control circuit (3) includes a microprocessor (62), high power switching elements (64) to drive the motor (1) and at least two control circuit inputs which include a piston position sensor (12) and a rack and drive train release sensor (11). The control circuit input(s) can be internal or external timers or single point or continuous reading sensors. The preferred design uses a start switch (10), at least one sensor (12) to detect a position of the compression piston (5), and one sensor (11) to detect when the rack and rack pinion have decoupled. It is also preferred to have a method of determining motor speed and FETs or relays to control power to the motor (1). Although these elements are used in the preferred design, it is understood by those familiar with the art that considerable simplification is possible without departing from the spirit of the invention. The cycle begins with the pressing of the start switch (10). Although the power can be directed to the motor (1) through the start switch (10), it is preferable to use Mosfets. In order to maintain responsiveness, it is desirable that the overall resistance from the power source (2) to the motor (1) be kept very low. A design parameter is that the overall circuit resistance from the power source (2) to the motor (1) may be less then 0.02 ohms per applied volt from the power source (2). The issue of temperature is important to the operation of an air spring driven tool. Therefore, in the preferred design, a thermister (21) or other sensor may be used to determine ambient temperature. This information can be used to determine the compression requirements in order to optimally drive the fastener.

Once power is applied to the motor (1), the cycle proceeds similar to the aforementioned description. The feedback elements such as the sensor (11) or the sensor (12) are used to determine the location of the piston (5) and whether the drive assembly has decoupled from the linear motion device. The control circuit (3) can control various functions including the venting of the cylinder to determine whether a jamb has occurred or not and braking of the motor. Preferably, the control circuit (3) determines if the decoupling has occurred and determines if the piston has not returned to the initial position in a predetermined amount of time, the valve (23) can be activated by the control circuit (3) if it is electrically controlled to remove the air pressure from the air chamber (13). A further embodiment of the present invention would include for the control circuit (3) to inhibit operation of the fastener device (100) in the case of a low battery. This would reduce the number of jambs by not allowing the fastener drive to begin unless there was sufficient energy to complete the cycle.

In the clutch embodiment, the clutch activation would preferably be inhibited by the control circuit (3) until the motor (1) was running at a fast enough speed to complete a drive cycle. It is understood by those skilled in the art that the sensors can be used in conjunction with circuit elements to allow location at different places and that sensors can be of many forms including but not limited to limit switches, hall effect sensors, photo sensors and reed switches without departing from the spirit of the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

We claim:

1. An apparatus for driving a fastener into a material comprising:
a power source;
a control circuit coupled to said power source;
a motor controlled by said control circuit;
a linear motion converter driven by said motor;
a piston detachably coupled to a portion of said linear motion converter;
a cylinder for reciprocating the piston;
an anvil coupled to said piston;
a sensor to detect a position of said linear motion converter;
wherein said portion of said linear motion converter is decoupled from said motor to drive a fastener.

2. An apparatus for driving a fastener into a material as in claim 1, wherein said linear motion converter includes a pinion with at least one tooth cutaway.

3. An apparatus for driving a fastener into a material as in claim 1, wherein said sensor detects the decoupling of the portion of said linear motion converter.

4. An apparatus for driving a fastener into a material as in claim 1, wherein a position of said linear motion converter is controlled by said control circuit.

5. An apparatus for driving a fastener into a material as in claim 1, wherein said apparatus includes an elastic element to bias said linear motion converter to a predetermined position.

6. An apparatus for driving a fastener into a material as in claim 1, wherein the linear motion converter includes a rack.

7. An apparatus for driving a fastener into a material as in claim 6, wherein the rack includes at least one tooth having a radiused profile.

8. An apparatus for driving a fastener into a material comprising:
a power source;
a control circuit coupled to said power source;
a motor controlled by said control circuit;
a linear motion converter driven by said motor;
a drive train including a clutch to couple said motor with said linear motion converter;
a piston coupled to said linear motion converter;
a cylinder for reciprocating the piston;
a fastener driving anvil coupled to said piston;
wherein said clutch is controlled by said control circuit to couple said motor with said linear motion converter.

9. An apparatus for driving a fastener into a material as in claim 8, wherein said apparatus includes a sensor to detect a position of the linear motion converter.

10. An apparatus for driving a fastener into a material as in claim 8, wherein the apparatus includes an elastic element to predispose the linear motion converter to a predetermined position

11. An apparatus for driving a fastener into a material as in claim 8, wherein said linear motion converter includes a rack and a pinion.

12. An apparatus for driving a fastener into a material as in claim 9, wherein said sensor detects a stall condition of said apparatus.

13. An apparatus for driving a fastener into a material as in claim 12, wherein said control circuit controls said clutch in response to said detected stall condition.

14. An apparatus for driving a fastener into a material as in claim 8, wherein said apparatus includes an air cylinder for compressed air and a compression of said compressed air is controlled by said clutch.

15. An apparatus for driving a fastener into a material as in claim 8, wherein air in said cylinder is vented when a jamb stall condition is detected.

16. An apparatus for driving a fastener into a material as in claim 8, wherein said control circuit monitors said power source to determine a low power supply condition.

17. An apparatus for driving a fastener into a material as in claim 8, wherein the clutch is a wrap spring clutch.

18. An apparatus for driving a fastener into a material comprising:
a power source;
a control circuit coupled to said power source;
a motor controlled by said control circuit;
a linear motion converter driven by said motor;
a piston coupled to said linear motion converter;
a cylinder for reciprocating the piston;
an anvil attached to said piston;
a sear pin which retains said piston in an energized state;
wherein when said sear pin is released, a portion of said linear motion converter is released to drive said fastener.

19. An apparatus for driving a fastener into a material as in claim 1, wherein said control circuit brakes the motor.

20. An apparatus for driving a fastener into a material as in claim 18, wherein the control circuit brakes the motor.

21. An apparatus for driving a fastener into a material as in claim 1, wherein air in said cylinder is vented when a jamb stall condition is detected.

22. An apparatus for driving a fastener into a material as in claim 1, wherein said control circuit monitors said power source to determine a low power supply condition.

23. An apparatus for driving a fastener into a material as in claim 18, wherein air in said cylinder is vented when a jamb stall condition is detected.

24. An apparatus for driving a fastener into a material as in claim 18, wherein said apparatus includes a sensor to detect a position of the linear motion converter.
